(19) United States
(12) Patent Application Publication
(10) Pub. No.: US 2015/0358914 A1
(43) Pub. Date: Dec. 10, 2015

(54) BS AND UE, AND POWER CONTROL METHODS USED IN THE SAME

(71) Applicant: TELEFONAKTIEBOLAGET L M ERICSSON (PUBL), Stockholm (SE)

(72) Inventors: Xinghua Song, Beijing (CN); Ali Behravan, Stockholm (SE); Erik Eriksson, Linköping (SE); Rui Fan, Beijing (CN); Zhiheng Guo, Beijing (CN); Jinhua Liu, Beijing (CN); Imadur Rahman, Sollentuna (SE); Eliane Semaan, Vällingby (SE)

(21) Appl. No.: 14/758,106

(22) PCT Filed: Aug. 8, 2013
(86) PCT No.: PCT/CN2013/081089

§ 371 Date: Jun. 26, 2015

(51) Int. Cl. H04W 52/14; H04W 74/00; H04L 5/14

(52) U.S. Cl. CPC H04W 52/146; H04L 5/14; H04W 74/006; H04W 88/08

(57) ABSTRACT

The present disclosure relates to a method used in a BS for controlling a UE to perform power control of uplink transmissions to the BS and an associated BS. The method includes: for each UL subframe scheduled by a UL grant, determining, for a UL subframe, a set of power control parameters to use for the UL subframe; and transmitting to the UE an indication indicating the set of power control parameters to use for the UL subframe. The present disclosure also relates to a method used in a UE for performing power control of uplink transmissions from the UE to a BS, and an associated UE.

### TECHNICAL FIELD

The technology presented in this disclosure generally relate to radio communication networks, particularly (though not exclusively) radio communication networks using Time Division Duplex (TDD), for example Long-Term Evolution (LTE) TDD. More particularly, the present disclosure relates to a method used in a base station (BS) for controlling a User Equipment (UE) to perform power control of uplink transmissions from the UE to the BS, and an associated BS, and a method used in a UE for performing power control of uplink transmissions from the UE to the BS, and an associated UE.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In a typical cellular radio system, user equipments (UEs) can communicate via a radio access network (RAN) to one or more core networks (CN). The RAN generally covers a geographical area which is divided into radio cell areas. Each radio cell area can be served by a base station (BS), e.g., a radio base station (RBS), which in some networks may also be called, for example, a “NodeB” (UMTS) or “eNodeB (eNB)” (LTE). A radio cell is a geographical area where radio coverage is generally provided by the radio base station at a base station site. Each radio cell can be identified by an identity within the local radio area, which is broadcast in the radio cell. The base stations communicate over the air interface operating on radio frequencies with the UEs within range of the base stations. In some radio access networks, several base stations may be connected (for example, by landlines or microwave) to a radio network controller (RNC) or a base station controller (BSC). The radio network controller may be configured to supervise and coordinate the various activities of the plurality of base stations connected thereto. The radio network controllers may also be connected to one or more core networks.

The Universal Mobile Telecommunications System (UMTS) is a third generation mobile communication system, which evolved from the Global System for Mobile Communications (GSM). The Universal Terrestrial Radio Access Network (UTRAN) is essentially a radio access network using Wideband Code Division Multiple Access (WCDMA) for UEs. As an alternative to WCDMA, Time Division Synchronous Code Division Multiple Access (TD-SCDMA) could be used. In a standardization forum known as the Third Generation Partnership Project (3GPP), telecommunications suppliers propose and agree upon standards for third generation networks and UTRAN specifically, and investigate e.g. enhanced data rate and radio capacity. The 3GPP has undertaken to evolve the UTRAN and GSM based radio access network technologies. The first releases for the Evolved Universal Terrestrial Radio Access Network (E-UTRAN) specification have been issued. The Evolved Universal Terrestrial Radio Access Network (E-UTRAN) comprises the Long Term Evolution (LTE) and System Architecture Evolution (SAE). Long Term Evolution (LTE) is a variant of a 3GPP radio access technology where the radio base station nodes are connected to a core network (e.g., via Access Gateways (AGWs)) rather than to radio network controller (RNC) nodes. In general, in LTE the functions of a radio network controller (RNC) node are distributed between the radio base stations nodes (eNodeB's in LTE) and AGWs. As such, the radio access network (RAN) of an LTE system has what is sometimes referred to as a “flat” architecture including radio base station nodes without reporting to radio network controller (RNC) nodes.

Transmission and reception from a node, e.g., a radio terminal like a UE in a cellular system such as LTE, can be multiplexed in the frequency domain or in the time domain (or combinations thereof). In Frequency Division Duplex (FDD), downlink (DL) and uplink (UL) transmission take place in different, sufficiently separated, frequency bands. In Time Division Duplex (TDD), DL and UL transmission take place in different, non-overlapping time slots. Thus, TDD can operate in unpaired frequency spectrum, whereas FDD generally requires paired frequency spectrum.

Typically, a transmitted signal in a radio communication system is organized in some form of frame structure, or frame configuration. For example, LTE generally uses ten equally sized subframes 0-9 of length 1 ms per radio frame as illustrated in FIG. 1. In case of TDD as shown in FIG. 1, there is generally only a single carrier frequency, and UL and DL transmissions are separated in time. Because the same carrier frequency is used for UL and downlink transmission, both the base station and the UEs need to switch from transmission to reception and vice versa. An important aspect of a TDD system is to provide a sufficiently large guard time where neither DL nor UL transmissions occur in order to avoid interference between UL and DL transmissions. For LTE, special subframes (e.g., subframe #1 and, in some cases, subframe #6) provide this guard time. A TDD special subframe is generally split into three parts: a downlink part (DwPTS), a guard period (GP), and an UL part (UpPTS). The remaining subframes are either allocated to UL or DL transmission. Example UL-DL TDD configurations (also referred to as “TDD configuration” in the present disclosure) are shown in Table 1 below. Also, exemplary special subframe configurations are shown in Table 2 below.

TABLE 1
Exemplary UL and DL configurations in TDD

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

TABLE 2
Example configurations of special subframe

| | Normal cyclic prefix | | | Extended cyclic prefix in | | |
|---|---|---|---|---|---|---|
| | in downlink | | | downlink | | |
| | | UpPTS | | | UpPTS | |
| | | Normal | | | Normal | |
| | | cyclic | Extended | | cyclic | Extended |
| Special | | prefix | cyclic | | prefix | cyclic |
| subframe | | in | prefix | | in | prefix in |
| configuration | DwPTS | uplink | in uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

TDD allows for different asymmetries in terms of the amount of resources allocated for UL and DL transmission, respectively, by means of different DL/UL configurations. In LTE, there are seven different configurations, see FIG. 2. Generally speaking, to avoid significant interference between DL and UL transmissions between different radio cells, neighboring radio cells should have the same DL/UL configuration. Otherwise, UL transmission in one radio cell may interfere with DL transmission in the neighboring radio cell (and vice versa). As a result, the DL/UL asymmetry generally does not vary between radio cells. The DL/UL asymmetry configuration is signaled, i.e. communicated, as part of the system information and can remain fixed for a long time.

Consequently, the TDD networks generally use a fixed frame configuration where some subframes are UL and some are DL. This may prevent or at least limit the flexibility to adopt the UL and/or DL resource asymmetry to varying radio traffic situations.

In future networks, it is envisioned that we will see more and more localized traffic, where most of the users will be in hotspots, or in indoor areas, or in residential areas. These users will be located in clusters and will produce different UL and DL traffic at different time. This essentially means that a dynamic feature to adjust the UL and DL resources to instantaneous (or near instantaneous) traffic variations would be required in future local area cells.

TDD has a potential feature where the usable band can be configured in different time slots to either in UL or DL. It allows for asymmetric UL/DL allocation, which is a TDD-specific property, and not possible in FDD. There are seven different UL/DL allocations in LTE, providing 40%-90% DL resources.

In the current networks, UL/DL configuration is semi-statically configured, thus it may not match the instantaneous traffic situation. This will result in inefficient resource utilization in both UL and DL, especially in cells with a small number of users. In order to provide a more flexible TDD configuration, so-called Dynamic TDD (also sometimes referred to as Flexible TDD) has therefore been introduced. Thus, Dynamic TDD configures the TDD UL/DL asymmetry to current traffic situation in order to optimize user experience. Dynamic TDD provides the ability of a subframe to be configured as “flexible” subframe. As a result, some subframes can be configured dynamically as either for UL transmission or for DL transmission. The subframes can for example be configured as either for UL transmission or DL transmission depending on e.g. the radio traffic situation in a cell. Accordingly, Dynamic TDD can be expected to achieve promising performance improvement in TDD systems when there is a potential load imbalance between UL and DL. Besides, Dynamic TDD approach can also be utilized to reduce network energy consumption. It is expected that dynamic UL/DL allocation (hence referred in this section “Dynamic TDD”) should provide a good match of allocated resources to instantaneous traffic.

### Sounding Reference Signals

As defined in TS 36.211 “Evolved Universal Terrestrial Radio Access (E-UTRA); Physical Channels and Modulation”, v11.3.0, Sounding reference signals (SRS) are known signals that have time duration of a single OFDM symbol and are transmitted by UEs so that the eNodeB can estimate different uplink-channel properties. These estimates may be used for uplink scheduling and link adaptation but also for downlink multiple antenna transmission, especially in case of TDD where the uplink and downlink use the same frequencies.

SRS can be transmitted in the last symbol of a 1 ms uplink subframe. For the case utilizing TDD, the SRS can also be transmitted in the special slot UpPTS. The length of UpPTS can be configured to be one or two symbols. As an example for TDD, FIG. 3 illustrates an example for TDD with a UL/DL configuration of 3DL: 2UL. In the example as shown in FIG. 3, within a 10 ms radio frame, up to eight symbols may be set aside for sounding reference signals.

The configuration of SRS symbols, such as SRS bandwidth, SRS frequency domain position, SRS hopping pattern and SRS subframe configuration are set semi-statically as a part of RRC information element (referring to 3GPP TS 36.331 “Evolved Universal Terrestrial Radio Access (E-UTRA); Radio Resource Control (RRC); Protocol specification”).

There are two types of SRS transmission in LTE UL, i.e., periodic SRS transmission and aperiodic SRS transmission. Periodic SRS is transmitted at regular time instances as configured by means of RRC signaling. Aperiodic SRS is one shot transmission that is triggered by signaling in PDCCH.

There are in fact two different configurations related to SRS:
Cell specific SRS configuration; and
UE specific SRS configuration.

The cell specific configuration in essence indicates what subframes may be used for SRS transmissions within the cell as illustrated in FIG. 3. The UE specific configuration indicates to the terminal a pattern of subframes (among the subframes reserved for SRS transmission within the cell) and frequency domain resources to be used for SRS transmission of that specific UE. It also includes other parameters that the UE shall use when transmitting the signal, such as frequency domain comb and cyclic shift.

This means that sounding reference signals from different UEs can be multiplexed in the time domain, by using UE-specific configurations such that the SRS of the two UEs are transmitted in different subframes. Furthermore, within the same symbol, sounding reference signals can be multiplexed in the frequency domain. The set of subcarriers is divided into two sets of subcarriers, i.e., combs with the even and odd subcarriers respectively in each such set. Additionally, UEs may have different bandwidths to get additional frequency domain multiplexing (FDM). The comb enables frequency domain multiplexing of signals with different bandwidths and also overlapping with each other. Additionally, code division multiplexing can be used. Then different users can use exactly the same time and frequency domain resources by using different shifts of a basic base sequence.

### Existing Power Control for PUSCH

In LTE, uplink power control is used to compensate for the channel path loss variations. When there is high attenuation between the UE and the base station, the UE increases its transmit power in order to maintain the received power at the base station at a desirable level.

The UE's transmit power for different type of channels follow different power control rules. If the UE transmits PUSCH without a simultaneous PUCCH for the serving cell c, then the UE transmit power P_{PUSCH,c}(i) for PUSCH transmission in subframe i for the serving cell cis given as (referring to TS 36.213, “Evolved Universal Terrestrial Radio Access (E-UTRA); Physical layer procedures”, v11.3.0):

$${P}_{PUSCH , c} ( i ) = min \{ \begin{matrix}{P}_{CMAX , c} ( i ) , \\ \begin{matrix}10 {log}_{10} ( {M}_{PUSCH , c} ( i ) ) + {P}_{O \_ PUSCH , c} ( j ) + \\ {α}_{c} ( j ) \cdot {PL}_{c} + {Δ}_{TF , c} ( i ) + {f}_{c} ( i )\end{matrix}\end{matrix} \} [ dBm ] ,$$

where
P_{CMAX,c} is the configured UE transmitted power;
M_{PUSCH,c}(i) is the bandwidth of the PUSCH resource assignment expressed in number of resource blocks valid for subframe i and serving cell c, P_{O}_{_{—}}_{PUSCH,c}(j) is a parameter composed of the sum of a component P_{O}_{_{—}}_{NOMINAL}_{_{—}}_{PUSCH,c}(j) provided from higher layers for j=0 and 1 and a component P_{O}_{_{—}}_{UE}_{_{—}}_{PUSCH,c}(j) provided by higher layers for j=0 and 1 for serving cell c;
α_{c}ε{0, 0.4, 0.5, 0.6, 0.7, 0.8, 0.9, 1} is a 3-bit parameter provided by higher layers for serving cell c;
PL_{c} is the downlink path-loss estimate calculated in the UE for serving cell c in dB;
Δ_{TF,c} is a dynamic offset given by higher layers;
f_{c}(i) is a function that represents accumulation of transmit power control (TPC) commands,
   if accumulation is enabled based on the parameter Accumulation-enabled provided by higher layers or if the TPC command δ_{PUSCH,c} is included in a Physical Downlink Control Channel/enhanced Physical Downlink Control Channel (PDCCH/ePDCCH) with DCI format 0 for serving cell c where the cyclic redundancy check (CRC) is scrambled by the Temporary C-RNTI, then f_{c}(i)=δ_{PUSCH,c}(i−K_{PUSCH})
   if accumulation is not enabled for serving cell c based on the parameter Accumulation-enabled provided by higher layers, then f_{c}(i)=δ_{PUSCH,c}(i−K_{PUSCH});
δ_{PUSCH,c} is a correction value, also referred to as a TPC command and is included in PDCCH/ePDCCH with DCI format 0/4 for serving cell c or jointly coded with other TPC commands in PDCCH with DCI format 3/3A whose CRC parity bits are scrambled with TPC-PUSCH-RNTI; and
For PUSCH (re)transmissions corresponding to a semi-persistent grant then j=0, for PUSCH (re)transmissions corresponding to a dynamic scheduled grant then j=1 and for PUSCH (re)transmissions corresponding to the random access response grant then j=2.

Among other things, P_{O}_{_{—}}_{NOMINAL}_{_{—}}_{PUSCH,c}(f) and α_{c}ε{0, 0.4, 0.5, 0.6, 0.7, 0.8, 0.9, 1} are two typical power control parameters.

A power control message is directed to a group of UEs using an RNTI specific to that group. Each terminal can be allocated two power control RNTIs, one for PUSCH power control and one for PUCCH power control.

Similar expressions for the case of PUCCH, SRS, and also for the case of simultaneous transmission of PUSCH and PUCCH can be found in TS 36.213, “Evolved Universal Terrestrial Radio Access (E-UTRA); Physical layer procedures”, v11.3.0.

### SUMMARY

It is in view of the above considerations and others that the various embodiments of the present technology have been made.

According to a first aspect of the present disclosure, there is proposed a method used in a BS for controlling a UE to perform power control of uplink transmissions from the UE to the BS. In the method, for each UL subframe scheduled by a UL grant, a set of power control parameters to use for the UL subframe is determined. Then, an indication indicating the set of power control parameters to use for the UL subframe is transmitted to the UE.

Preferably, the uplink transmissions may include one or more of: a PUSCH transmission; a PUCCH transmission; or an aperiodic SRS transmission.

According to a second aspect of the present disclosure, there is proposed a method used in a UE for performing power control of uplink transmissions from the UE to a BS. The method includes: receiving from the BS, for each UL subframe scheduled by a single UL grant, an indication indicating a set of power control parameters to use for the UL subframe; and performing power control on the uplink transmissions in the UL subframe based on the set of power control parameters.

According to a third aspect of the present disclosure, there is proposed a BS for controlling a UE to perform power control of uplink transmissions from the UE to the BS. The BS may include: a determining unit configured to, for each UL subframe scheduled by a UL grant, determine a set of power control parameters to use for the UL subframe; and a transmitting unit configured to transmit to the UE an indication indicating the set of power control parameters to use for the UL subframe.

According to a fourth aspect of the present disclosure, there is proposed a UE for perform power control of uplink transmissions from the UE to a BS. The UE may include: a receiving unit configured to receive from the BS, for each UL subframe scheduled by a single UL grant, an indication indicating a set of power control parameters to use for the UL subframe; and a power control performing unit configured to perform power control on the uplink transmissions in the UL subframe based on the set of power control parameters.

Accordingly, the present disclosure proposes several signaling methods to support dynamic selection from multiple sets of power control parameters for e.g., PUSCH, PUCCH and SRS.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates uplink/downlink time/frequency structure for LTE TDD.

FIG. 2 is a diagram illustrating an example of seven different downlink/uplink configurations for LTE TDD.

FIG. 3 illustrates an example for TDD with a UL/DL configuration of 3DL: 2UL.

FIG. 4 illustrates an example wireless communication scenario where the present application may be applied.

FIG. 5 illustrates an example dynamic TDD configuration.

FIG. 6 is a flowchart of a method 600 according to some embodiments of the present disclosure.

FIG. 7 is a flowchart of a method 700 used in a UE located in a cell served by a BS according to some embodiments of the present disclosure.

FIG. 8 is a schematic block diagram of BS 800 according to some embodiments of the present disclosure.

FIG. 9 is a schematic block diagram of UE 900 according to some embodiments of the present disclosure.

FIG. 10 schematically shows an embodiment of an arrangement 1000 which may be used in the BS 800 or the UE 900.

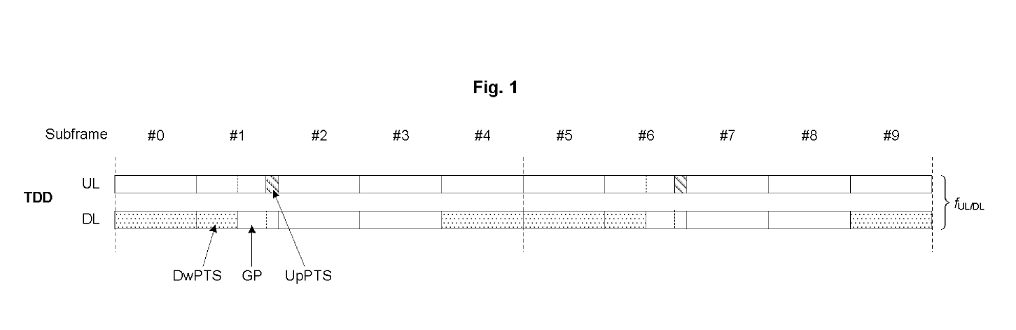

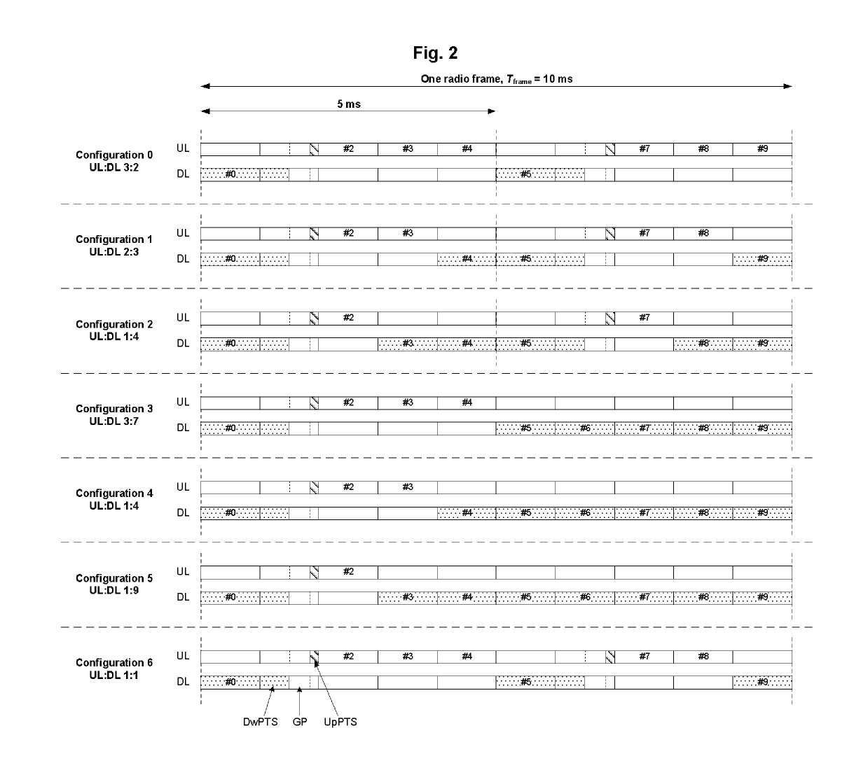

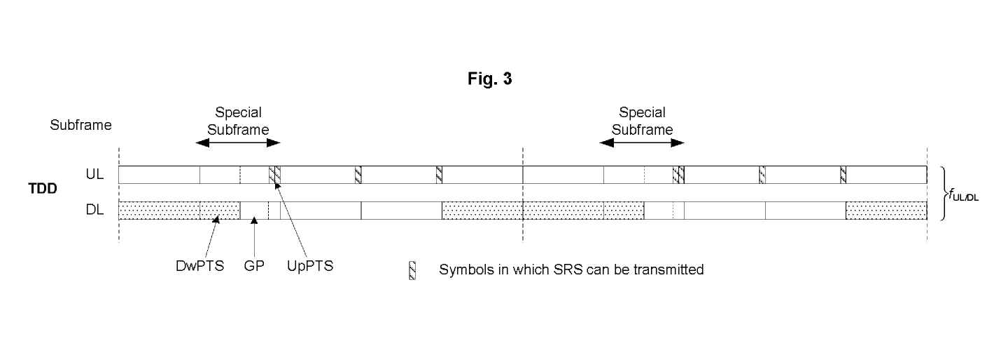

### DETAILED DESCRIPTION OF EMBODIMENTS

In the following description, for purposes of explanation and not limitation, specific details are set forth such as particular architectures, interfaces, techniques, etc. However, it will be apparent to those skilled in the art that the technology described here may be practiced in other embodiments that depart from these specific details. That is, those skilled in the art will be able to devise various arrangements which, although not explicitly described or shown herein, embody the principles of the technology described and are included within its scope. In some instances, detailed descriptions of well-known devices, circuits, and methods are omitted so as not to obscure the description with unnecessary detail. All statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that block diagrams herein can represent conceptual views of illustrative circuitry embodying the principles of the technology. Similarly, it will be appreciated that any flow charts and the like represent various processes which may be substantially represented in computer readable medium and so executed by a computer or processor, whether or not such computer or processor is explicitly shown. The functions of the various elements including functional blocks labeled or described as “processor” may be provided through the use of dedicated hardware as well as hardware capable of executing software in the form of coded instructions stored on computer readable medium. When provided by a processor, the functions may be provided by a single dedicated processor, by a single shared processor, or by a plurality of individual processors, some of which may be shared or distributed. Such functions are to be understood as being computer-implemented and thus machine-implemented. Moreover, use of the term “processor” or shall also be construed to refer to other hardware capable of performing such functions and/or executing software, and may include, without limitation, digital signal processor (DSP) hardware, reduced instruction set processor, hardware (e.g., digital or analog) circuitry, and (where appropriate) state machines capable of performing such functions.

As used hereinafter, it should be appreciated the term UE may be referred to as a mobile terminal, a terminal, a user terminal (UT), a wireless terminal, a wireless communication device, a wireless transmit/receive unit (WTRU), a mobile phone, a cell phone, etc. Yet further, the term UE includes MTC (Machine Type Communication) devices, which do not necessarily involve human interaction. Also, the term “radio network node” as used herein generally denotes a fixed point being capable of communicating with the UE. As such, it may be referred to as a base station, a radio base station, a NodeB or an evolved NodeB (eNB), access point, relay node, etcetera.

Using Dynamic TDD causes BS to BS interference and UE to UE interference between cells with different TDD configurations. For a certain cell, this results in the probability that some of the UL subframes (including fixed UL and flexible UL subframes) experience the UE-to-UE (i.e. UL-to-DL) interference while some of the other subframes experience the BS-to-BS (i.e. DL-to-UL) interference.

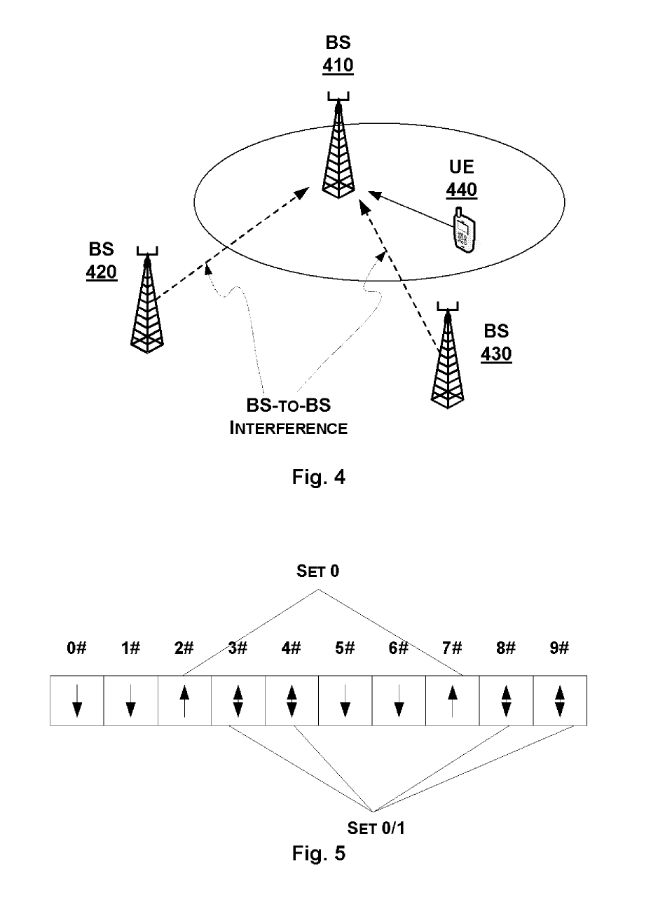

FIG. 4 illustrates an example wireless communication scenario where BS to BS interference may occur. As shown in FIG. 4, there are three base stations, denoted as BS 410, BS 420 and BS 430, respectively, and one UE, i.e., UE 440, served by BS 410. It will be appreciated that there may be less or more BSs, and there may be more than one UE. Cells served by BS 420 and 430 may be referred to UE 440's neighbor cells. Hereinafter, a UE's neighbor cells may generally refer to cells neighboring a cell, where the UE is located.

For one subframe, it is assumed that it is configured as an UL subframe for BS 410, i.e., there is an uplink transmission between BS 410 and UE 440, but it is configured as a DL subframe for both of BS 420 and BS 430. In this case, as shown in FIG. 4, DL transmissions of BS 420 and BS 430 in the subframe may interfere the UL transmission between BS 410 and UE 440. This is so-called BS-to-BS interference.

In case of BS-to-BS interference, due to the possible considerable interference differences between different UL subframes, using unified power control schemes and configurations may result in considerable perceived quality (e.g., Signal-to-Interference-and-Noise-Ratio (SINR), Block Error Rate (BLER), etc.) difference and may degrade the system performance. One solution to this may be UL power control, where in case of BS-to-BS interference, UL power control is used to increase the signal power from the UE. In this case, different types of subframes should be provided with different sets of power control parameters.

FIG. 5 illustrates an example dynamic TDD configuration, where subframe 2 and subframe 7 are configured as fixed UL subframes, while subframes 3, 4, 8 and 9 are configured as flexible subframes. The conventional power control technology may be applied for the fixed subframes, while dynamic selection of two sets of power control parameters may be applied for the flexible subframes depending on the type of inter-cell interference. That is, different types of subframes may be provided with different sets of power control parameters. In this way, in order to select a set of relevant power control parameters for PUSCH, PUCCH or SRS transmission in a subset of subframes, a trigger is needed.

The issues related to signaling different sets of power control parameters for different UL channels to the UE are considered in the present disclosure.

The present disclosure proposes several signaling methods to support dynamic selection from multiple power control parameter settings for PUSCH, PUCCH and SRS, respectively.

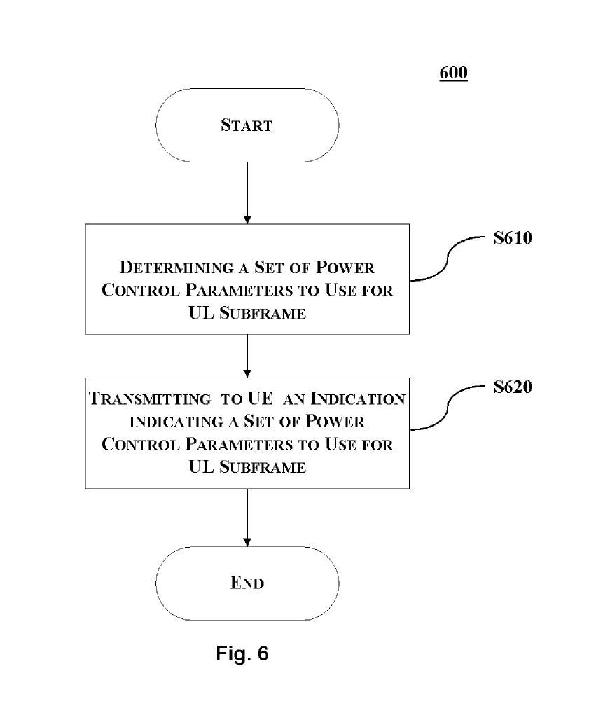

FIG. 6 shows a flowchart of the method 600 according to some embodiments of the present disclosure. The method is used in a BS for controlling a UE to perform power control of uplink transmissions from the UE to the BS. The BS and UE may be comprised in a radio communication network applying dynamic TDD.

Referring to FIG. 6, for each UL subframe scheduled by a UL grant, the BS may determine a set of power control parameters to use for the UL subframe (step S610). The set of power control parameters may include as parameters, e.g., P_{O}_{_{—}}_{NOMINAL}_{_{—}}_{PUSCH,c} and α_{c}ε{0, 0.4, 0.5, 0.6, 0.7, 0.8, 0.9, 1} having different values in different sets.

As an example, the set of power control parameters to use for the UL subframe may be determined based on dynamic TDD configuration(s) of the UE's neighbor cell(s).

At step S620, the BS transmits to the UE an indication indicating the determined set of power control parameters to use for the UL subframe.

As an example, the indication may be transmitted in DCI. For example, the indication indicating which set of power control parameters to use for the UL subframe may be transmitted by adding new information field to the UL DCI.

To save signaling bits, for example, the same set of power control parameters may be used for all UL subframes indicated in the DCI. The present disclosure is not limited to this, and different sets of power control parameters may be used for different subframes indicated in the DCI.

In accordance with the present disclosure, the method 600 may further include a step of determining the number of bits to use for carrying the indication based on the maximum sum of sets of power control parameters available for UL subframes scheduled by a single UL grant (not shown).

For example, the maximum sum may be expressed as:
N=Max {Sum(Number of sets of power control parameters available for UL subframe i, where UL subframe i is scheduled by a single k^{th} UL grant), k is an integer and the k^{th} UL grant represents any UL grant sent in a DL subframe}

Then, the number of bits to use for carrying the indication may be ceiling{log 2(N)}.

For example, for TDD configuration 0, subframe 4 and subframe 7 can be scheduled by an UL grant in subframe 0 with the information field UL index set to “11”. If two sets of power control parameters in subframe 4 are supported and one set of power control parameters in subframe 7 is supported, then the number of bits needed for dynamic power control is ceil{log 2(2+1)}=2 bits.

Furthermore, the number of sets of power control parameters per subframe may be based on dynamic TDD configurations used in the UE's X nearest cells, in which dynamic TDD is applied. Here, X is any positive integer and can be defined based on the interference between base stations. In this case, the number of sets of power control parameters per subframe may be equal to X. For instance, for each UL subframe in a victim cell, the number of sets of power control parameters may be determined based on the corresponding UL/DL allocations in that specific subframe in the X nearest cells.

For example, assume that a victim cell has configuration 0, then the number of sets of power control parameters that should be signaled to the UE for subframe 3 may be determined based on the total number of DL allocations in subframe 3 in the X nearest cells.

As another example, the indication may be transmitted in bits for TPC.

In this example, the existing bits for TPC are reused for indicating the set of power control parameters to use. If two sets are configured one TPC bit can be used for selecting the parameter while the other bit could be used as a TPC command. The TPC command may be an absolute command or an accumulative command dependent on configuration. Different steps could be defined for the different command types. This would result in a slower power control due to lower granularity in the step-sizes, but give large flexibility without any additional overhead. If 4 sets are configured both TPC bits could be used for set indication. In another embodiment, a new DCI format for TPC may be defined, which includes both open-loop power control parameter set indication and closed-loop power control adjustment. For example, a format 3B may be defined with same size as format 3A. For each user, 2 bits may be used to indicate open-loop power control parameter set selection and 2 bits may be used for closed-loop power control adjustment.

As yet another example, the indication may correspond to one unique Cell Radio Network Temporary Identifier (C-RNTI) or Transmit Power Control-Physical Uplink Shared Channel-Radio Network Temporary Identifier (TPC-PUSCH-RNTI), and different C-RNTIs or TPC-PUSCH-RNTIs may correspond to different sets of power control parameters.

When applying C-RNTI as the indication, multiple C-RNTIs may be used for different sets of power control parameters. The CRC bits used for UL scheduling grants are scrambled with different C-RNTIs corresponding to different sets of power control parameters corresponding to different power control settings.

When applying TPC-PUSCH-RNTI as the indication, multiple TPC-PUSCH-RNTIs may be used for different power control settings. The CRC bits used for TPC commands are scrambled with different TPC-PUSCH-RNTIs corresponding to different sets of power control parameters.

In this example, the number of C-RNTIs or TPC-PUSCH-RNTIs depends on, e.g., the number of sets of power control parameters available for the UL subframe.

In accordance with the present disclosure, the uplink transmissions may include one or more of: a PUSCH transmission; a PUCCH transmission; or an aperiodic SRS transmission.

If the uplink transmissions include an aperiodic SRS transmission, the indication may be transmitted to the UE when the aperiodic SRS transmission is being triggered. The trigger for the aperiodic SRS transmission may be sent in (e)PDCCH as part of DCI format 0 or 4. TPC selection may be sent together with the trigger for the aperiodic SRS transmission as part of a current DCI format or on a new downlink control information.

If the uplink transmissions include all of PUSCH transmission, PUCCH transmission, and aperiodic SRS transmission, the set of power control parameters may include three subsets of power control parameters for PUSCH, PUCCH, and SRS transmission, respectively. That is, once a UE identifies a set of power control parameters for a UL subframe indicated by the eNB, the UE can determine special subsets of power control parameters for PUCCH transmission, PUSCH transmission, and SRS transmission in the UL subframe, respectively.

The UL subframes may be associated to certain sets of power control parameters semi-statically according to interference changes, so that there is no need to transmit respective indications for each UL subframe or each channel on transmission time interval (TTI) basis.

The method 600 may further include a step of transmitting one or more sets of power control parameters available for the UL subframe and respective corresponding indications to the UE via RRC signaling (not shown).

As a further example, the indication may be transmitted to the UE via PDCCH or other signaling semi-statically. For example, the indication may be carried over a PDCCH (or ePDCCH) together with the TDD UL-DL reconfiguration signaling.

As another further example, the applicable set of power control parameters for a UL subframe may be configured periodically or conditionally. As an example, the indication may be transmitted to the UE only when a TDD configuration of the UE's dominant aggressor cell is changed.

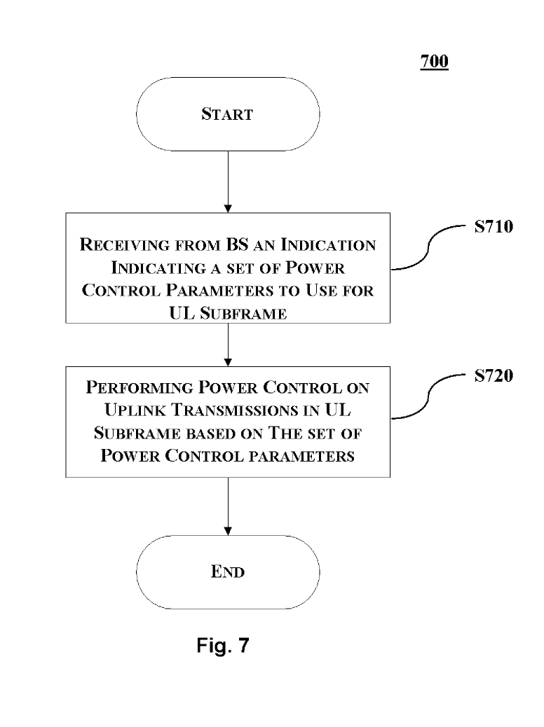

FIG. 7 shows a flowchart of the method 700 used in a UE for performing power control of uplink transmissions from the UE to a BS according to some embodiments of the present disclosure.

Referring to FIG. 7, for each UL subframe scheduled by a single UL grant, the UE receives from the BS an indication indicating the set of power control parameters to use for the UL subframe (step S710). The set of power control parameters may include as parameters, e.g., P_{O}_{_{—}}_{NOMINAL}_{_{—}}_{PUSCH,c}(j) and α_{c}ε{0, 0.4, 0.5, 0.6, 0.7, 0.8, 0.9, 1} having different values in different sets.

As an example, the set of power control parameters to use for the UL subframe may be determined based on dynamic TDD configuration(s) of the UE's neighbor cell(s).

At step S720, the UE performs power control on the uplink transmissions in the UL subframe based on the set of power control parameters. For example, the UE may perform the power control in accordance with the existing power control technology mentioned in the Background.

As an example, the indication may be received in DCI. For example, the indication indicating which set of power control parameters to use for the UL subframe may be transmitted by adding new information field to the UL DCI

To save signaling bits, for example, the same set of power control parameters may be used for all UL subframes indicated in the DCI. The present disclosure is not limited to this, and different sets of power control parameters may be used for different subframes indicated in the DCI.

In accordance with the present disclosure, the number of bits to use for carrying the indication is determined based on the maximum sum of sets of power control parameters available for UL subframes scheduled by a single UL grant.

For example, the maximum sum may be expressed as:
N=Max {Sum(Number of sets of power control parameters available for UL subframe i, where UL subframe i is scheduled by a single k^{th} UL grant), k is an integer and the k^{th} UL grant represents any UL grant sent in a DL subframe}

Then, the number of bits to use for carrying the indication may be ceil{log 2(N)}.

As another example, the indication may be received in bits for TPC.

In this example, the existing bits for TPC are reused for indicating the set of power control parameters to use. If two sets are configured one TPC bit can be used for selecting the parameter while the other bit could be used as a TPC command. The TPC command may be an absolute command or an accumulative command dependent on configuration. Different steps could be defined for the different command types. This would result in a slower power control due to lower granularity in the step-sizes, but give large flexibility without any additional overhead. If 4 sets are configured both TPC bits could be used for set indication. In another embodiment, a new DCI format for TPC may be defined, which includes both open-loop power control parameter set indication and closed-loop power control adjustment. As an example, a format 3B may be defined with same size as format 3A. For each user, 2 bits may be used to indicate open-loop power control parameter set selection and 2 bits may be used for closed-loop power control adjustment.

As yet another example, the indication may correspond to one unique C-RNTI or TPC-PUSCH-RNTI, and different C-RNTIs or TPC-PUSCH-RNTIs may correspond to different sets of power control parameters.

When applying C-RNTI as the indication, multiple C-RNTIs may be used for different sets of power control parameters. The CRC bits used for UL scheduling grants are scrambled with different C-RNTIs corresponding to different sets of power control parameters corresponding to different power control settings.

When applying TPC-PUSCH-RNTI as the indication, multiple TPC-PUSCH-RNTIs may be used for different power control settings. The CRC bits used for TPC commands are scrambled with different TPC-PUSCH-RNTIs corresponding to different sets of power control parameters.

In this example, the number of C-RNTIs or TPC-PUSCH-RNTIs depends on, e.g., the number of sets of power control parameters available for the UL subframe.

In accordance with the present disclosure, the uplink transmissions may include one or more of: a PUSCH transmission; a PUCCH transmission; or an aperiodic SRS transmission.

If the uplink transmissions include an aperiodic SRS transmission, the indication may be transmitted to the UE when the aperiodic SRS transmission is being triggered. The trigger for the aperiodic SRS transmission may be sent in (e)PDCCH as part of DCI format 0 or 4. TPC selection may be sent together with the trigger for the aperiodic SRS transmission as part of a current DCI format on a new downlink control information.

If the uplink transmissions include all of PUSCH transmission, PUCCH transmission, and aperiodic SRS transmission, the set of power control parameters may include three subsets of power control parameters for PUSCH, PUCCH, and SRS transmission, respectively. That is, once a UE identifies a set of power control parameters for a UL subframe indicated by the eNB, the UE can determine special subsets of power control parameters for PUCCH transmission, PUSCH transmission, and SRS transmission in the UL subframe, respectively.

The UL subframes may be associated to certain sets of power control parameters semi-statically according to interference changes, so that there is no need to transmit respective indications for each UL subframe or each channel on TTI basis.

The method 700 may further include a step of receiving one or more sets of power control parameters available for the UL subframe and respective corresponding indications from the BS via RRC signaling (not shown).

As a further example, the indication may be received from the BS via PDCCH or other signaling semi-statically. For example, the indication may be carried over a PDCCH (or ePDCCH) together with the TDD UL-DL reconfiguration signaling.

As another further example, the applicable set of power control parameters for a UL subframe may be configured periodically or conditionally. As an example, the indication may be received from the BS only when a TDD configuration of the UE's dominant aggressor cell is changed.

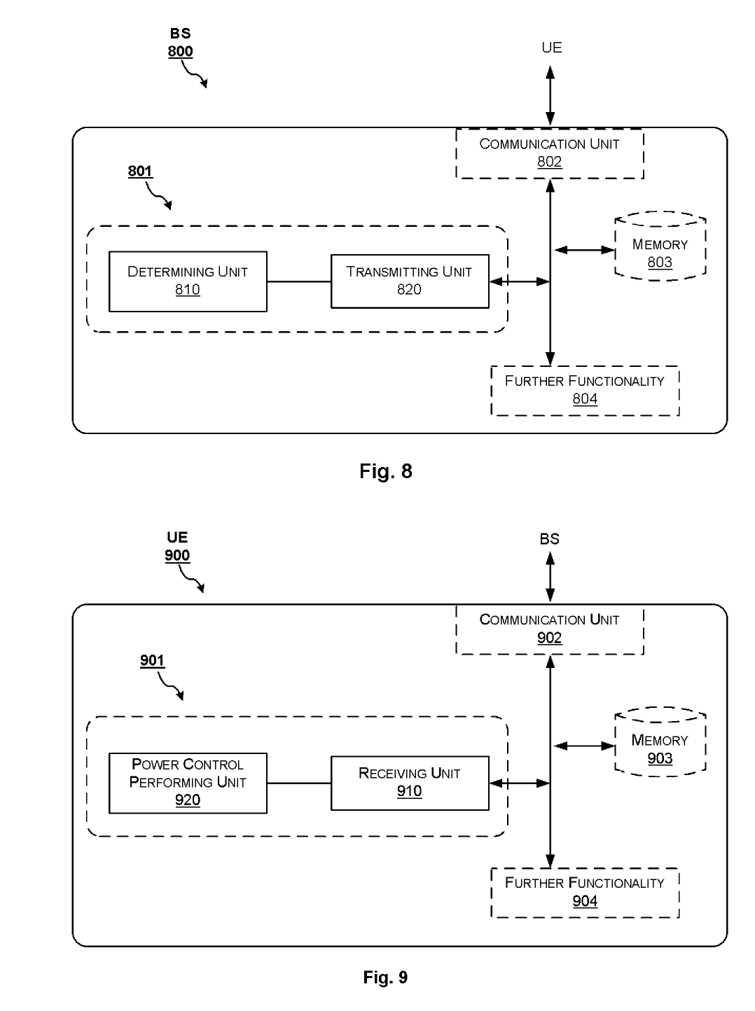

FIG. 8 is a schematic block diagram of BS 800 for controlling a UE to perform power control of uplink transmissions from the UE to the BS according to some embodiments of the present disclosure.

The part of BS 800 which is most affected by the adaptation to the herein described method is illustrated as an arrangement 801, surrounded by a dashed line. The BS 800 could be e.g. an eNB, or a NodeB, depending on in which type of communication system it is operable, e.g., LTE-type systems or (W)CDMA-type systems. The BS 800 and arrangement 801 are further configured to communicate with other entities via a communication unit 802 which may be regarded as part of the arrangement 801. The communication unit 802 comprises means for wireless communication, and may comprise means for, e.g., wired communication. The arrangement 801 or BS 800 may further comprise other functional units 804, such as functional units providing regular eNB functions, and may further comprise one or more storage units 803.

The arrangement 801 may be implemented, e.g., by one or more of: a processor or a micro processor and adequate software and memory for storing of the software, a Programmable Logic Device (PLD) or other electronic component(s) or processing circuitry configured to perform the actions described above, and illustrated, e.g., in FIG. 6. The arrangement part of the BS 800 may be implemented and/or described as follows.

Referring to FIG. 8, BS 800 may include a determining unit 810 and a transmitting unit 820.

The determining unit 810 may determine, for each UL subframe scheduled by a UL grant, a set of power control parameters to use for the UL subframe.

The transmitting unit 820 may transmit to the UE an indication indicating the set of power control parameters to use for the UL subframe.

The determining unit 810 may determine the set of power control parameters to use for the UL subframe based on dynamic TDD configuration(s) of the UE's neighbor cell(s).

As an example, the transmitting unit 820 may transmit the indication in DCI. In this example, different sets of power control parameters may be used for different subframes indicated in the DCI, or the same set of power control parameters may be used for all UL subframes indicated in the DCI.

As another example, the transmitting unit 820 may transmit the indication in bits for TPC.

In accordance with the present disclosure, the indication may correspond to one unique C-RNTI or TPC-PUSCH-RNTI, and different C-RNTIs or TPC-PUSCH-RNTIs may correspond to different sets of power control parameters. In this case, the number of C-RNTIs or TPC-PUSCH-RNTIs may depend on, e.g., the number of sets of power control parameters available for the UL subframe.

The determining unit 810 may determine the number of bits to use for carrying the indication based on the maximum sum of sets of power control parameters available for UL subframes scheduled by a single UL grant. For example, the maximum sum may be equal to the number of the UE's nearest cell(s), in which dynamic TDD is applied.

In accordance with the present disclosure, the uplink transmissions may include one or more of:
a PUSCH transmission;
a PUCCH transmission; or
an aperiodic SRS transmission.

If the uplink transmissions include an aperiodic SRS transmission, the transmitting unit 820 may transmit the indication to the UE when the aperiodic SRS transmission is being triggered.

If the uplink transmissions include all of PUSCH transmission, PUCCH transmission, and aperiodic SRS transmission, the set of power control parameters may include three subsets of power control parameters for PUSCH, PUCCH, and SRS transmission, respectively.

The transmitting unit 820 may transmit one or more sets of power control parameters available for the UL subframe and respective corresponding indications to the UE via RRC signaling.

FIG. 9 is a schematic block diagram of UE 900 for performing power control of uplink transmissions from the UE to a BS according to some embodiments of the present disclosure.

The part of UE 900 which is most affected by the adaptation to the herein described method, e.g., the method 700, is illustrated as an arrangement 901, surrounded by a dashed line. The UE 900 could be, e.g., a mobile terminal, depending on in which type of communication system it is operable, e.g., LTE-type systems or (W)CDMA-type systems. The UE 900 and arrangement 901 are further configured to communicate with other entities via a communication unit 902 which may be regarded as part of the arrangement 901. The communication unit 902 comprises means for wireless communication. The arrangement 901 or UE 900 may further comprise other functional units 904, such as functional units providing regular UE functions, and may further comprise one or more storage units 903.

The arrangement 901 could be implemented, e.g., by one or more of: a processor or a micro processor and adequate software and memory for storing of the software, a Programmable Logic Device (PLD) or other electronic component(s) or processing circuitry configured to perform the actions described above, and illustrated, e.g., in FIG. 7. The arrangement part of the UE 900 may be implemented and/or described as follows.

Referring to FIG. 9, UE 900 may include a receiving unit 910 and a power control performing unit 920.

The receiving unit 910 may receive from the BS, for each UL subframe scheduled by a single UL grant, an indication indicating a set of power control parameters to use for the UL subframe.

The power control performing unit 920 may perform power control on the uplink transmissions in the UL subframe based on the set of power control parameters.

The set of power control parameters to use for the UL subframe may be determined based on, e.g., dynamic TDD configuration(s) of the UE's neighbor cell(s).

As an example, the receiving unit 910 may receive the indication in DCI. In this example, different sets of power control parameters may be used for different subframes indicated in the DCI, or the same set of power control parameters may be used for all UL subframes indicated in the DCI.

As another example, the receiving unit 910 may receive the indication in bits for TPC.

In accordance with the present disclosure, the indication may correspond to one unique C-RNTI or TPC-PUSCH-RNTI, and different C-RNTIs or TPC-PUSCH-RNTIs may correspond to different sets of power control parameters.

In this case, the number of C-RNTIs or TPC-PUSCH-RNTIs depends on, e.g., the number of sets of power control parameters available for the UL subframe.

As an example, the number of bits to use for carrying the indication may be determined based on the maximum sum of sets of power control parameters available for UL subframes scheduled by a single UL grant. For example, the maximum sum may be equal to the number of the UE's nearest cell(s), in which dynamic TDD is applied.

In accordance with the present disclosure, the uplink transmissions may include one or more of:
a PUSCH transmission;
a PUCCH transmission; or
an aperiodic SRS transmission.

If the uplink transmissions include all of PUSCH transmission, PUCCH transmission, and aperiodic SRS transmission, the set of power control parameters may include three subsets of power control parameters for PUSCH, PUCCH, and SRS transmission, respectively.

The receiving unit 910 may receive one or more sets of power control parameters available for the UL subframe and respective corresponding indications from the BS via RRC signaling.

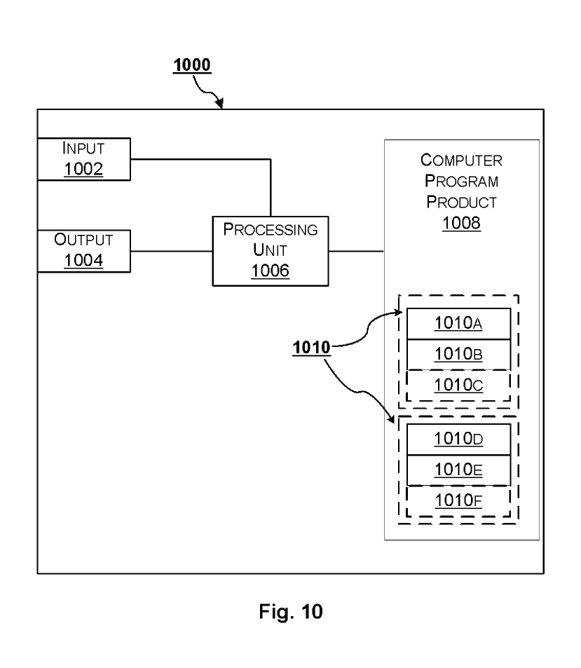

FIG. 10 schematically shows an embodiment of an arrangement 1000 which may be used in the BS 800 or the UE 900. Comprised in the arrangement 1000 are here a processing unit 1006, e.g., with a Digital Signal Processor (DSP). The processing unit 1006 may be a single unit or a plurality of units to perform different actions of procedures described herein. The arrangement 1000 may also comprise an input unit 1002 for receiving signals from other entities, and an output unit 1004 for providing signal(s) to other entities. The input unit and the output unit may be arranged as an integrated entity or as illustrated in the example of FIG. 8 or FIG. 9.

Furthermore, the arrangement 1000 may comprise at least one computer program product 1008 in the form of a non-volatile or volatile memory, e.g., an Electrically Erasable Programmable Read-Only Memory (EEPROM), a flash memory and a hard drive. The computer program product 1008 comprises a computer program 1010, which comprises code/computer readable instructions, which when executed by the processing unit 1006 in the arrangement 1000 causes the arrangement 1000 and/or the BS or the UE in which it is comprised to perform the actions, e.g., of the procedure described earlier in conjunction with FIG. 6 or FIG. 7. The computer program 1010 may be configured as a computer program code structured in computer program modules 1010A-1010C or 1010D-1010F.

Hence, in an exemplifying embodiment when the arrangement 1000 is used in the BS 800, the code in the computer program of the arrangement 1000 includes a determining module 1010A, for determining, for each UL subframe scheduled by a UL grant, a set of power control parameters to use for the UL subframe. The code in the computer program 1010 further includes a transmitting module 1010B, for transmitting to the UE an indication indicating the set of power control parameters to use for the UL subframe by using a corresponding indication. The code in the computer program 1010 may comprise further modules, illustrated as module 1010C, e.g. for controlling and performing other related procedures associated with BS's operations.

In another exemplifying embodiment when the arrangement 1000 is used in the UE 900, the code in the computer program of the arrangement 1000 includes a receiving module 1010D, for receiving from the BS, for each UL subframe scheduled by a signal UL grant, an indication indicating a set of power control parameters to use for the UL subframe. The code in the computer program further includes a power control performing module 1010E, for performing power control on the uplink transmissions in the UL subframe based on the set of power control parameters. The code in the computer program 1010 may comprise further modules, illustrated as module 1010F, e.g. for controlling and performing other related procedures associated with UE's operations.

The computer program modules could essentially perform the actions of the flow illustrated in FIG. 6, to emulate the arrangement 801 in the BS 800, or the actions of the flow illustrated in FIG. 7, to emulate the arrangement 901 in the UE 900. In other words, when the different computer program modules are executed in the processing unit 1006, they may correspond, e.g., to the units 810-820 of FIG. 8 or to the units 910-920 of FIG. 9.

Although the code means in the embodiments disclosed above in conjunction with FIG. 10 are implemented as computer program modules which when executed in the processing unit causes the device to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the BS.

Although the present technology has been described above with reference to specific embodiments, it is not intended to be limited to the specific form set forth herein. For example, the embodiments presented herein are not limited to power control for PUSCH, PUCCH and SRS transmissions; rather they are equally applicable to other appropriate UL transmissions. The technology is limited only by the accompanying claims and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

1. A method used in a Base Station, BS, for controlling a User Equipment, UE, to perform power control of uplink transmissions to the BS, the method comprising:
determining, for each UpLink, UL, subframe scheduled by a UL grant, a set of power control parameters to use for the UL subframe; and
transmitting to the UE an indication indicating the set of power control parameters to use for the UL subframe.

2. The method according to claim 1, wherein the set of power control parameters to use for the UL subframe is determined based on dynamic Time Division Duplex, TDD, configurations of the UE's neighbor cell(s).

3. The method according to claim 1, wherein, the indication is transmitted in Downlink Control Information, DCI.

4. The method according to claim 3, wherein,
different sets of power control parameters are used for different subframes indicated in the DCI, or
the same set of power control parameters is used for all UL subframes indicated in the DCI.

5. The method according to claim 1, wherein the indication is transmitted in bits for Transmit Power Control, TPC.

6. The method according to claim 1, wherein the indication corresponds to one unique Cell Radio Network Temporary Identifier, C-RNTI, or Transmit Power Control-Physical Uplink Shared Channel-Radio Network Temporary Identifier, TPC-PUSCH-RNTI), and different C-RNTIs or TPC-PUSCH-RNTIs correspond to different sets of power control parameters.

7. The method according to claim 6, wherein the number of C-RNTIs or TPC-PUSCH-RNTIs depends on the number of sets of power control parameters available for the UL subframe.

8. The method according to claim 1, further comprising:
determining the number of bits to use for carrying the indication based on the maximum sum of sets of power control parameters available for UL subframes scheduled by a single UL grant.

9. The method according to claim 8, wherein, the maximum sum is equal to the number of the UE's nearest cell(s), in which dynamic Time Division Duplex, TDD) is applied.

10. The method according to claim 1, wherein the uplink transmissions include one or more of:
a Physical Uplink Shared Channel, PUSCH, transmission;
a Physical Uplink Control Channel, PUCCH, transmission; or
an aperiodic Sounding Reference Signal, SRS, transmission.

11. The method according to claim 10, wherein, if the uplink transmissions include an aperiodic SRS transmission, the indication is transmitted to the UE when the aperiodic SRS transmission is being triggered.

12. The method according to claim 10, wherein, if the uplink transmissions include all of PUSCH transmission, PUCCH transmission, and aperiodic SRS transmission, the set of power control parameters include three subsets of power control parameters for PUSCH, PUCCH, and SRS transmission, respectively.

13. The method according to claim 1, further comprising:
transmitting one or more sets of power control parameters available for the UL subframe and respective corresponding indications to the UE via Radio Resource Control, RRC, signaling.

14. A method used in a User Equipment, UE, for performing power control of uplink transmissions from the UE to a Base Station, BS, the method comprising:
receiving from the BS, for each UpLink, UL, subframe scheduled by a single UL grant, an indication indicating a set of power control parameters to use for the UL subframe; and
performing power control on the uplink transmissions in the UL subframe based on the set of power control parameters.

15. The method according to claim 14, wherein the set of power control parameters to use for the UL subframe is determined based on dynamic Time Division Duplex, TDD, configurations of the UE's neighbor cell(s).

16. The method according to claim 14, wherein the indication is received in Downlink Control Information, DCI.

17. The method according to claim 16, wherein,
different sets of power control parameters are used for each subframe indicated in the DCI, or
the same set of power control parameters is used for all UL subframes indicated in the DCI.

18. The method according to claim 14, wherein the indication is received in bits for TPC.

19. The method according to claim 14, wherein the indication corresponds to one unique Cell Radio Network Temporary Identifier, C-RNTI, or Transmit Power Control-Physical Uplink Shared Channel-Radio Network Temporary Identifier, TPC-PUSCH-RNTI, and different C-RNTIs or TPC-PUSCH-RNTIs correspond to different sets of power control parameters.

20. The method according to claim 19, wherein the number of C-RNTIs or TPC-PUSCH-RNTIs depends on the number of sets of power control parameters available for the UL subframe.

21. The method according to claim 14, wherein the number of bits to use for carrying the indication is determined based on the maximum sum of sets of power control parameters available for UL subframes scheduled by a single UL grant.

22. The method according to claim 21, wherein, the maximum sum is equal to the number of the UE's nearest cell(s), in which dynamic Time Division Duplex, TDD, is applied.

23. The method according to claim 14, wherein the uplink transmissions include one or more of:
a Physical Uplink Shared Channel, PUSCH, transmission;
a Physical Uplink Control Channel, PUCCH, transmission; or
an aperiodic Sounding Reference Signal, SRS, transmission.

24. The method according to claim 23, wherein, if the uplink transmissions include all of PUSCH transmission, PUCCH transmission, and aperiodic SRS transmission, the set of power control parameters include three subsets of power control parameters for PUSCH, PUCCH, and SRS transmission, respectively.

25. The method according to claim 14, further comprising:
receiving one or more sets of power control parameters available for the UL subframe and respective corresponding indications from the BS via Radio Resource Control, RRC, signaling.

26. A Base Station, BS, for controlling a User Equipment, UE, to perform power control of uplink transmissions to the BS, the BS comprising:
a determining unit configured to, for each UpLink, UL, subframe scheduled by a UL grant, determine a set of power control parameters to use for the UL subframe; and
a transmitting unit configured to transmit to the UE an indication indicating the set of power control parameters to use for the UL subframe.

27. The BS according to claim 26, wherein the determining unit determines the set of power control parameters to use for the UL subframe based on dynamic Time Division Duplex, TDD, configurations of the UE's neighbor cell(s).

28. The BS according to claim 26, wherein the transmitting unit is configured to transmit the indication in Downlink Control Information, DCI.

29. The BS according to claim 28, wherein,
different sets of power control parameters are used for different subframes indicated in the DCI, or
the same set of power control parameters is used for all UL subframes indicated in the DCI.

30. The BS according to claim 26, the transmitting unit is configured to transmit the indication in bits for Transmit Power Control, TPC.

31. The BS according to claim 26, wherein the indication corresponds to one unique Cell Radio Network Temporary Identifier, C-RNTI, or Transmit Power Control-Physical Uplink Shared Channel-Radio Network Temporary Identifier, TPC-PUSCH-RNTI, and different C-RNTIs or TPC-PUSCH-RNTIs correspond to different sets of power control parameters.

32. The BS according to claim 31, wherein the number of C-RNTIs or TPC-PUSCH-RNTIs depends on the number of sets of power control parameters available for the UL subframe.

33. The BS according to claim 26, wherein the determining unit is further configured to:
determine the number of bits to use for carrying the indication based on the maximum sum of sets of power control parameters available for UL subframes scheduled by a single UL grant.

34. The BS according to claim 33, wherein, the maximum sum is equal to the number of the UE's nearest cell(s), in which dynamic Time Division Duplex, TDD, is applied.

35. The BS according to claim 26, wherein the uplink transmissions include one or more of:
a Physical Uplink Shared Channel, PUSCH, transmission;
a Physical Uplink Control Channel, PUCCH, transmission; or
an aperiodic Sounding Reference Signal, SRS, transmission.

36. The BS according to claim 35, wherein, if the uplink transmissions include an aperiodic SRS transmission, the transmitting unit is configured to transmit the indication to the UE when the aperiodic SRS transmission is being triggered.

37. The BS according to claim 35, wherein, if the uplink transmissions include all of PUSCH transmission, PUCCH transmission, and aperiodic SRS transmission, the set of power control parameters include three subsets of power control parameters for PUSCH, PUCCH, and SRS transmission, respectively.

38. The BS according to claim 26, wherein the transmitting unit is further configured to:
transmit one or more sets of power control parameters available for the UL subframe and respective corresponding indications to the UE via Radio Resource Control, RRC, signaling.

39. A User Equipment, UE, for performing power control of uplink transmissions from the UE to a Base Station, BS, the UE comprising:
a receiving unit configured to receive from the BS, for each UpLink, UL, subframe scheduled by a UL grant, an indication indicating a set of power control parameters to use for the UL subframe; and
a power control performing unit configured to perform power control on the uplink transmissions in the UL subframe based on the set of power control parameters.

40. The UE according to claim 39, wherein the set of power control parameters to use for the UL subframe is determined based on dynamic Time Division Duplex, TDD, configurations of the UE's neighbor cell(s).

41. The UE according to claim 39, wherein the receiving unit is configured to receive the indication in Downlink Control Information, DCI.

42. The UE according to claim 41, wherein,
different sets of power control parameters are used for different subframes indicated in the DCI, or
the same set of power control parameters is used for all UL subframes indicated in the DCI.

43. The UE according to claim 39, wherein the receiving unit is configured to receive the indication in bits for Transmit Power Control, TPC.

44. The UE according to claim 39, wherein the indication corresponds to one unique Cell Radio Network Temporary Identifier, C-RNTI, or Transmit Power Control-Physical Uplink Shared Channel-Radio Network Temporary Identifier, TPC-PUSCH-RNTI, and different C-RNTIs or TPC-PUSCH-RNTIs correspond to different sets of power control parameters.

45. The UE according to claim 44, wherein the number of C-RNTIs or TPC-PUSCH-RNTIs depends on the number of sets of power control parameters available for the UL subframe.

46. The UE according to claim 39, wherein the number of bits to use for carrying the indication is determined based on the maximum sum of sets of power control parameters available for UL subframes scheduled by a single UL grant.

47. The UE according to claim 46, wherein, the maximum sum is equal to the number of the UE's nearest cell(s), in which dynamic Time Division Duplex, TDD, is applied.

48. The UE according to claim 39, wherein the uplink transmissions include one or more of:
a Physical Uplink Shared Channel, PUSCH, transmission;
a Physical Uplink Control Channel, PUCCH, transmission; or
an aperiodic Sounding Reference Signal, SRS, transmission.

49. The UE according to claim 48, wherein, if the uplink transmissions include all of PUSCH transmission, PUCCH transmission, and aperiodic SRS transmission, the set of power control parameters include three subsets of power control parameters for PUSCH, PUCCH, and SRS transmission, respectively.

50. The UE according to claim 39, wherein the receiving unit is further configured to:
receive one or more sets of power control parameters available for the UL subframe and respective corresponding indications from the BS via Radio Resource Control, RRC, signaling.
